(19) United States
(12) Patent Application Publication
(10) Pub. No.: US 2013/0064061 A1
(43) Pub. Date: Mar. 14, 2013

(54) MARK FORMING APPARATUS AND MARK FORMING METHOD

(71) Applicant: Akiya Saito, Kanagawa (JP)

(72) Inventor: Akiya Saito, Kanagawa (JP)

(73) Assignees: SONY DADC CORPORATION, Tokyo (JP); SONY CORPORATION, Tokyo (JP)

(21) Appl. No.: 13/596,389

(22) Filed: Aug. 28, 2012

(30) Foreign Application Priority Data
Sep. 6, 2011 (JP) 2011-193453

(51) Int. Cl. G11B 20/10

(52) U.S. Cl. 369/59.11; G9B/20.009

(57) ABSTRACT

Provided is a mark forming apparatus including a head unit that forms a mark on a recording medium through laser beam irradiation based on a laser driving pulse, a control signal generation unit that generates a control signal at a start timing of the laser driving pulse supplied to the head unit, a multiplier that multiples a synchronization reference signal used to synchronize with the process of forming the mark on the recording medium in the head unit to generate a multiple signal, and a laser driving pulse generation unit that generates the laser driving pulse by setting the start timing of the laser driving pulse at resolution based on the multiple signal in accordance with the control signal.

### CROSS-REFERENCE TO RELATED APPLICATION

The present application claims priority from Japanese Patent Application No. JP 2011-193453 filed in the Japanese Patent Office on Sep. 6, 2011, the entire content of which is incorporated herein by reference

### BACKGROUND

The present disclosure relates to a mark forming apparatus and a mark forming method, and more particularly, a technology for forming marks on a recording medium such as an optical disc through laser beam irradiation.

Japanese Unexamined Patent Application Publication No. 2009-070458 is an example of the related art.

For example, in recording apparatuses that perform recording on optical discs or mastering apparatuses that create masters of optical discs, a laser light source is driven using a laser driving pulse generated in accordance with an information signal, a laser beam is output, and the laser beam is irradiated to an optical disc or a master to form marks.

### SUMMARY

In general, a laser driving pulse is generated through a process synchronized with a rotation synchronization signal (synchronization clock) of an optical disc. Therefore, resolution of the positions (mark start timing) of marks formed on the optical disc is determined by the frequency of the rotation synchronization signal (synchronization clock), the upper limit of the number of pulses in one rotation, or the like. For this reason, the marks may not be formed at desired positions in some cases, even when the marks are attempted to be formed at the desired position on the optical disc.

It is desirable to provide a mark forming apparatus and a mark forming method capable of forming marks with the high degree of freedom at higher resolution.

According to an embodiment of the present disclosure, there is provided a mark forming apparatus including a head unit that forms a mark on a recording medium through laser beam irradiation based on a laser driving pulse, a control signal generation unit that generates a control signal at a start timing of the laser driving pulse supplied to the head unit, a multiplier that multiples a synchronization reference signal used to synchronize with the process of forming the mark on the recording medium in the head unit to generate a multiple signal, and a laser driving pulse generation unit that generates the laser driving pulse by setting the start timing of the laser driving pulse at resolution based on the multiple signal in accordance with the control signal.

According to an embodiment of the present disclosure, there is provided a mark forming method including generating a control signal at a start timing of a laser driving pulse, multiplying a synchronization reference signal synchronized with a process of forming a mark on a recording medium to generate a multiple signal, generating the laser driving pulse by setting the starting timing of the laser driving pulse at resolution based on the multiple signal in accordance with the control signal, and forming the mark on the recording medium through laser beam irradiation based on the generated laser driving pulse.

In the mark forming apparatus according to the embodiment of the present disclosure, the pulse timing of the laser driving pulse can be controlled at the resolution of the multiple signal obtained by multiplying the synchronization reference signal. Thus, the positions of the marks formed on the recording medium can be controlled at the resolution of a multiple signal higher than the resolution of the synchronization reference signal.

“Mark” is a generic term referring to various marks formed on a recording medium, such as an embossed pit mark, a phase-change mark, a pigment-change mark, an interference pattern mark, a refractive-index change mark, a void (hole) mark, and an exposed mark.

According to the embodiments of the present disclosure, the positions of the marks formed on the recording medium can be controlled at the higher resolution. Thus, it is possible to obtain the advantage of forming the marks with the higher degree of freedom.

### BRIEF DESCRIPTION OF THE DRAWINGS

FIG. 1 is a block diagram illustrating a mark forming apparatus according to embodiments of the present disclosure;

FIGS. 2A to 2D are diagrams illustrating laser driving pulses according to a first embodiment;

FIGS. 3A to 3F are diagrams illustrating various waveforms used to generate the laser driving pulses according to the first embodiment;

FIG. 4 is a diagram illustrating an example of marks according to the embodiment;

FIGS. 5A to 5D are diagrams illustrating generation of the laser driving pulses used to form the marks in FIG. 4;

FIGS. 6A to 6C are diagrams illustrating examples of marks formed in accordance with the embodiment;

FIGS. 7A to 7F are diagrams illustrating laser driving pulses according to a second embodiment;

FIGS. 8A to 8F are diagrams illustrating laser driving pulses according to a third embodiment;

FIGS. 9A and 9B are diagrams illustrating examples of marks formed in accordance with a fourth embodiment;

FIGS. 10A to 10E are diagrams illustrating laser driving pulses according to the fourth embodiment;

FIGS. 11A to 11E are diagrams illustrating laser driving pulses according to the fourth embodiment;

FIG. 12 is a diagram illustrating a BCA of an optical disc;

FIGS. 13A and 13B are diagrams illustrating a case in which marks are formed in the BCA according to the embodiment; and

FIGS. 14A and 14B are diagrams illustrating a case in which the marks are formed in the BCA according to the embodiment.

### DETAILED DESCRIPTION OF THE EMBODIMENTS

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Hereinafter, embodiments will be described in the following order.

1. Configuration of Mark Forming Apparatus

2. Generation of Laser Driving Pulse according to First Embodiment

3. Generation of Laser Driving Pulse according to Second Embodiment

4. Generation of Laser Driving Pulse according to Third Embodiment

5. Generation of Laser Driving Pulse according to Fourth Embodiment

6. Example Applied to BCA

7. Modified Examples

### 1. CONFIGURATION OF MARK FORMING APPARATUS

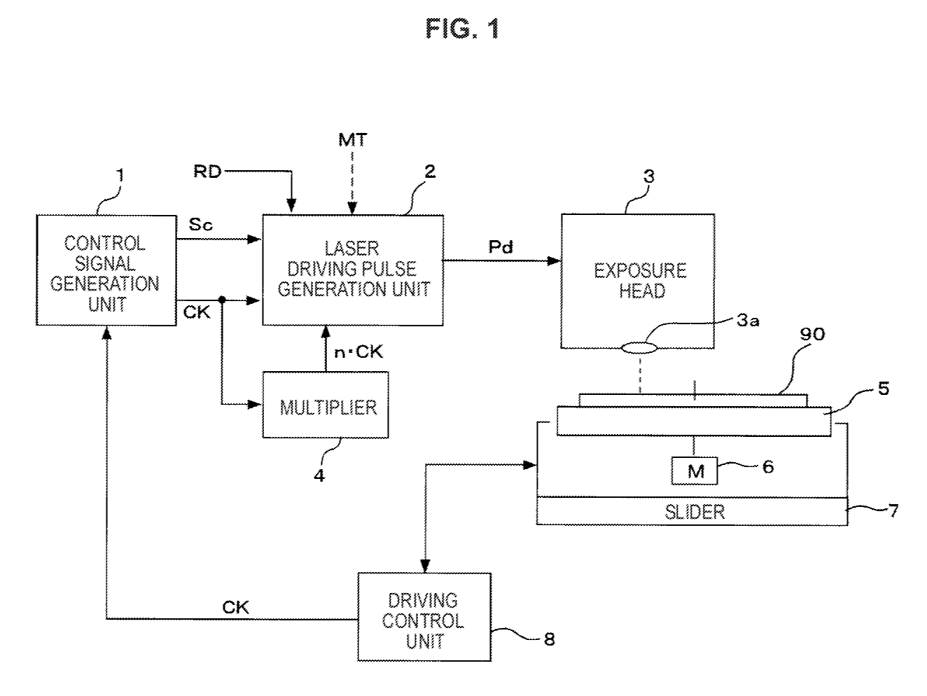

The configuration of a mark forming apparatus will be described with reference to FIG. 1. Hereinafter, a mastering apparatus creating a master disc will be described as an example of a mark forming apparatus according to embodiments of the present disclosure.

Examples of a mark formed on a recording medium such as an optical disc by the mark forming apparatus according to the embodiments include an embossed pit mark, a phase-change mark, a pigment-change mark, an interference pattern mark, a refractive-index change mark, a void (hole) mark, and an exposed mark. In FIG. 1, the mark is assumed to be an exposed mark formed on a master disc 90 as a recording medium.

In the master disc 90, a resist film formed on a surface of the master disc 90 is exposed through laser irradiation of the mastering apparatus, and the exposed portions are turned to concave portions through a development process. That is, the exposed portions are formed in a pattern of a pit line. A stamper is created from the master disc 90, and an optical disc is manufactured using the stamper. In the manufactured optical disc, portions exposed on the master disc 90 are turned to pits.

Accordingly, the mark forming apparatus (mastering apparatus) shown in FIG. 1 forms portions to be turned to pits on an optical disc, which is a final product, as exposed marks. In the embodiments, positions at which such exposed marks are formed can be controlled with high resolution.

The mark forming apparatus shown in FIG. 1 includes a control signal generation unit 1, a laser driving pulse generation unit 2, an exposure head unit 3, a multiplier 4, a turntable 5, a spindle motor 6, a slider 7, and a driving control unit 8.

An exposure laser light source, a necessary optical system, an objective lens 3a, and the like are mounted on the exposure head unit 3. The laser light source performs irradiation based on a laser driving pulse Pd from the laser driving pulse generation unit 2.

The master disc 90 is irradiated with the exposure laser beam from the objective lens 3a.

The master disc 90 is mounted on the turntable 5 and is rotated by the spindle motor 6. The master disc 90 is rotated while the rotation speed of the master disc 90 is controlled by the spindle motor 6 and the driving control unit 8. Thus, the master disc 90 is rotated at, for example, a constant linear velocity or a constant angular velocity.

The slider 7 moves the turntable 5 on which the master disc 90 is mounted. That is, a track of an exposed mark line is formed in a spiral shape by causing the exposure head unit 3 to expose the master disc 90 while the master disc 90 which is being rotated by the spindle motor 6 is moved in a radial direction by the slider 7. The slider 7 is driven in a slide manner at a predetermined speed by the driving control unit 8.

The driving control unit 8 controls the driving of the spindle motor 6 and the slider 7. The driving control unit 8 generates a clock (rotation synchronization clock CK) synchronized with the rotation of the spindle motor 6 and supplies the generated clock to the control signal generation unit 1. The rotation synchronization clock CK is a clock used to control the rotation of the spindle motor 6 or a clock which is a multiple of the clock.

The control signal generation unit 1 generates and outputs a control signal Sc of a start timing of the laser driving pulse supplied from the laser driving pulse generation unit 2 to the exposure head unit 3 through a process based on the rotation synchronization clock CK. The control signal Sc to be described in detail below is a signal used to form a specific mark pattern on the master disc 90.

The control signal generation unit 1 supplies the rotation synchronization clock CK to the multiplier 4 and the laser driving pulse generation unit 2.

The multiplier 4 generates a multiple clock n·CK which is a multiple of the rotation synchronization clock CK and supplies the multiple clock n·CK to the laser driving pulse generation unit 2. For example, the multiplier 4 multiplies the rotation synchronization clock CK by 4 and outputs the multiple clock n·CK with a fourfold frequency.

The multiplier 4 may be provided in the laser driving pulse generation unit 2. Further, the multiplier 4 may be provided in the driving control unit 8 and the driving control unit 8 may supply the multiple clock n·CK to the laser driving pulse generation unit 2.

The laser driving pulse generation unit 2 generates the laser driving pulse Pd and supplies the laser driving pulse Pd to the exposure head unit 3.

To perform a general mastering process, recording data RD is supplied from a recording data generation unit (not shown) to the laser driving pulse generation unit 2. The laser driving pulse generation unit 2 generates the laser driving pulse Pd in a strategy pattern corresponding to the recording data RD. The laser driving pulse generation unit 2 generates the laser driving pulse Pd in the strategy pattern corresponding to a run length such as 2T, 3T, or 4T (where T is a channel clock period) in accordance with an NRZi modulation signal of the recording data. Thus, exposed marks are formed on the master disc 90 so that a pit line corresponding to the recording data can be formed. For example, the master disc 90 used to manufacture an optical disc on which data is recorded in an embossed pit line is created.

In particular, here, the laser driving pulse Pd based on the control signal Sc is generated when marks are not formed based on recording data. For example, when marks (for example, 2T marks) with a specific run length are attempted to be formed at desired positions on the master disc 90, the laser driving pulse generation unit 2 can generate the laser driving pulse Pd for the 2T marks based on the control signal Sc. That is, a process of forming marks not based on recording data can be performed.

For example, this process is a process that is performed when a burst cutting area (BCA) to be described below is formed or drawing is performed using pit marks on a disc.

In this case, the laser driving pulse generation unit 2 generates the laser driving pulse Pd by setting a start timing of the laser driving pulse Pd at resolution based on the multiple clock n·CK in accordance with the control signal Sc.

As indicated by a dashed line, for example, a run-length designation signal MT can be supplied to the laser driving pulse generation unit 2, which will be described in a fourth embodiment.

### 2. GENERATION OF LASER DRIVING PULSE ACCORDING TO FIRST EMBODIMENT

A process of generating the laser driving pulse will be described according to a first embodiment. In the process of generating the laser driving pulse, the control signal generation unit 1 supplies the control signal Sc to the laser driving pulse generation unit 2, and then the laser driving pulse generation unit 2 generates the laser driving pulse Pd used to form marks with a specific run length by setting a start timing of the laser driving pulse Pd at resolution based on the multiple clock n·CK in accordance with the control signal Sc. The exposure head unit 3 performs laser irradiation in accordance with the generated laser driving pulse Pd to form exposed marks on the master disc 90.

This process is not an exposure process based on the recording data RD but a process of forming the exposed marks at desired positions on the master disc 90 and forming pits at desired positions on an optical disc manufactured using the master disc 90 as an original disc.

Here, an example in which the laser driving pulse Pd used to form 2T marks is generated as the laser driving pulse Pd used to form marks with a specific run length will be described.

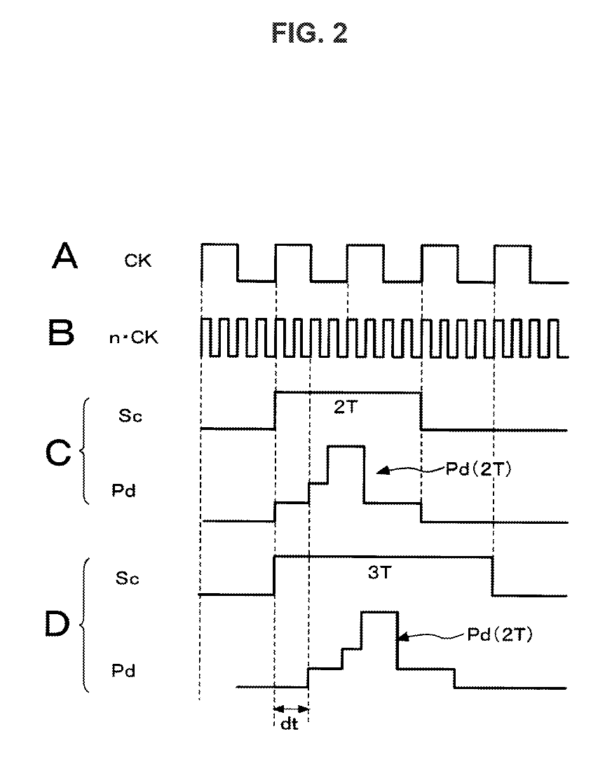

FIGS. 2A to 2D are diagrams illustrating signal waveforms from the units.

FIG. 2A shows the rotation synchronization clock CK. FIG. 2B shows the multiple clock n·CK. The multiple clock n·CK is a clock which is a fourfold clock of the rotation synchronization clock CK.

FIGS. 2C and 2D show the control signal Sc output by the control signal generation unit 1 and the laser driving pulse Pd output by the laser driving pulse generation unit 2.

The control signal generation unit 1 generates the control signal Sc as a multiple-value signal that expresses two or higher-based values in a pulse length in a time-axis direction. FIG. 2C shows the control signal Sc that expresses a “first value” as a pulse with a 2T length. FIG. 2D shows the control signal Sc that expresses a “second value” as a pulse with a 3T length. For example, the control signal Sc expresses a control value which is multi-valued in a pulse length in a time direction.

The laser driving pulses Pd shown in FIGS. 2C and 2D have a strategy waveform for a 2T mark. As disclosed in the related art, various strategy waveforms with various T lengths are considered. The strategy waveform for the 2T mark illustrated as a strategy waveform with a step-shaped pulse shape is merely an example used for the description.

Hereinafter, the laser driving pulse Pd for the 2T mark is denoted as “Pd(2T).”

As shown in FIG. 2C, the laser driving pulse generation unit 2 generates a laser driving pulse Pd(2T) in accordance with the control signal Sc with the 2T length.

The laser driving pulse generation unit 2 generates the laser driving pulse Pd(2T) irrespective of the value of the control signal Sc, but changes a start timing of the laser driving pulse Pd(2T) in accordance with the value of the control signal Sc. That is, the laser driving pulse generation unit 2 generates the laser driving pulse Pd(2T) by setting the start timing of the laser driving pulse Pd(2T) at resolution based on the multiple clock n·CK in accordance with the control signal Sc.

In FIG. 2C, the laser driving pulse Pd(2T) is configured to start at the timing of the multiple clock n·CK which coincides with the rising timing of the rotation synchronization clock CK.

As shown in FIG. 2D, the laser driving pulse generation unit 2 generates the same laser driving pulse Pd(2T) in accordance with the control signal Sc with a 3T length. In this case, the same laser driving pulse Pd(2T) for the 2T mark is generated, but the start timing is set as a timing delayed only by a period dt corresponding to a ½ period from the rising of the rotation synchronization clock CK. That is, the laser driving pulse Pd(2T) is generated so as to be delayed by two clocks using the multiple clock n·CK.

The laser beam (pulse beam) irradiated based on the laser driving pulse Pd(2T) for the control signal Sc of the second value shown in FIG. 2D by the exposure head unit 3 is irradiated at a timing shifted by a ½ clock of the rotation synchronization clock CK from the laser beam (pulse beam) for the control signal Sc of the first value. The exposed mark on the master disc 90 is formed at a position shifted by a ½ clock from the position synchronized with the rotation synchronization clock CK.

That is, in this embodiment, the strategy waveform is controlled as the laser driving pulse Pd at a timing synchronized with the multiple clock n·CK in accordance with the control signal Sc. Thus, the pulse timing that is more minute than the rotation synchronization clock CK can be controlled, and thus the positions of the exposed marks can be controlled.

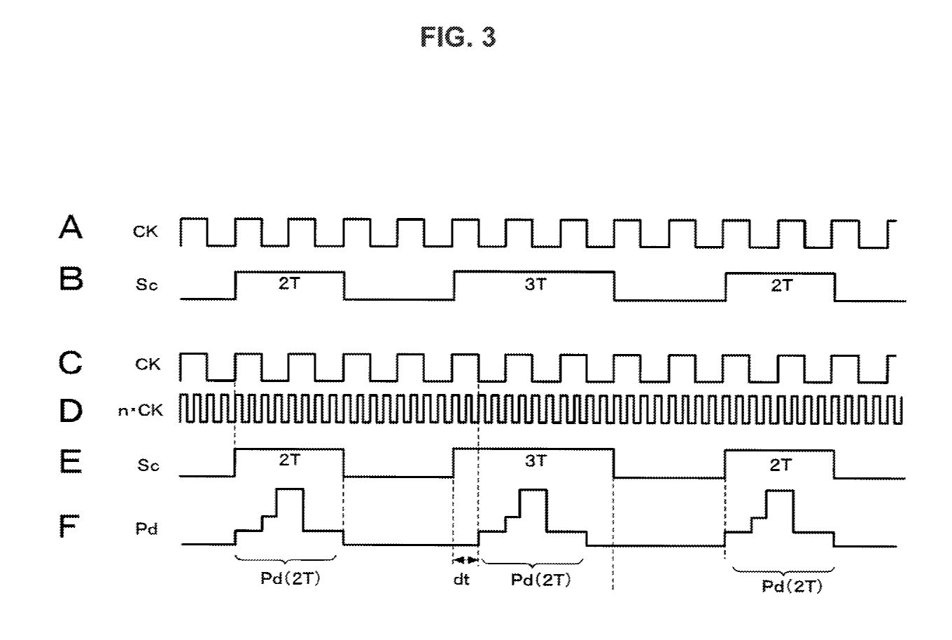

FIGS. 3A to 3F are diagrams illustrating examples of laser driving pulses Pd generated sequentially in accordance with the control signal Sc.

FIG. 3A shows a rotation synchronization clock CK input to and output from the control signal generation unit 1. FIG. 3B shows the control signal Sc. As shown in FIG. 3B, the first value of the pulse with the 2T length and the second value of the pulse with the 3T length are sequentially output as the control signal Sc.

FIG. 3C shows the rotation synchronization clock CK input by the laser driving pulse generation unit 2. FIG. 3D shows the multiple clock n·CK. FIG. 3E shows the control signal Sc input by the laser driving pulse generation unit 2.

The laser driving pulse generation unit 2 generates the laser driving pulse Pd(2T) used to form the 2T mark by setting a timing synchronized with the multiple clock n·CK in accordance with the control signal Sc.

As shown in the drawings, when the control signal Sc has the first value, the laser driving pulse Pd(2T) is output at a timing synchronized with the rotation synchronization clock CK. When the control signal Sc has the second value, the laser driving pulse Pd(2T) is output at a timing delayed only by the period dt which is a ½ period of the rotation synchronization clock CK.

In the first embodiment, as described above, the mark forming apparatus includes the control signal generation unit 1 that generates the control signal Sc obtained through multi-valuing of mark position information; the multiplier 4 that multiplies the rotation synchronization clock CK; and the laser driving pulse generation unit 2 that generates the laser driving pulse Pd(2T) used to form the mark with a specific T length (for example, a 2T length) by controlling the start timing of the laser driving pulse Pd(2T) using the multiple clock n·CK in accordance with the control signal Sc. Thus, the positions of the marks can be controlled with higher resolution than the rotation synchronization clock CK.

Further, the start timing is controlled using the multiple clock n·CK generated from the rotation synchronization clock CK synchronized with the rotation of the master disc 90. Therefore, even when the linear velocity is constant and the angular velocity is constant in the disc rotation driving method, the process of this example is applicable.

An example of an actual mark forming process will be described.

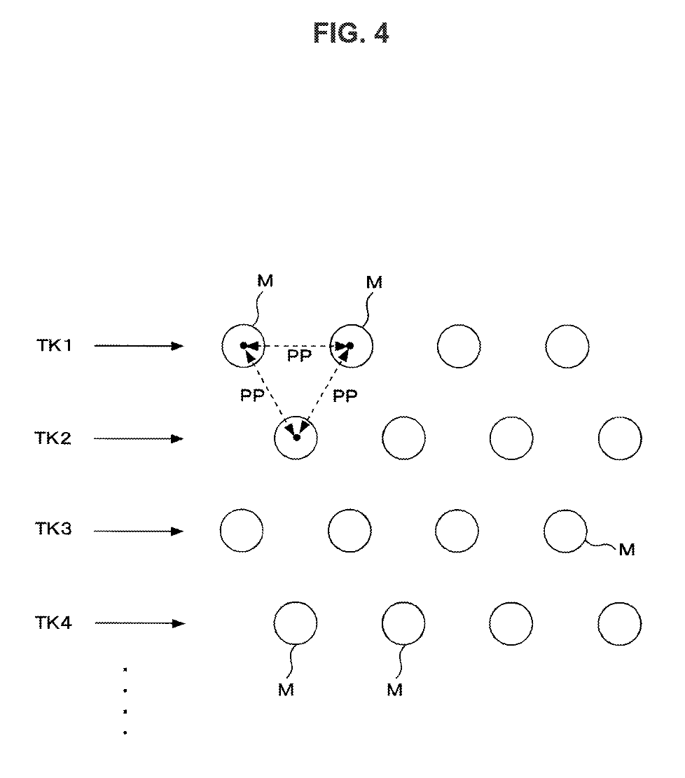

As in FIG. 4, marks M (which are pits with the 2T length on a manufactured optical disc) with the 2T length are attempted to be arranged on the master disc 90.

As indicated by a dashed line, the marks M are arranged in a zigzag form so that distances between the marks M are all a distance PP and the marks M are located at the vertexes of a regular triangle.

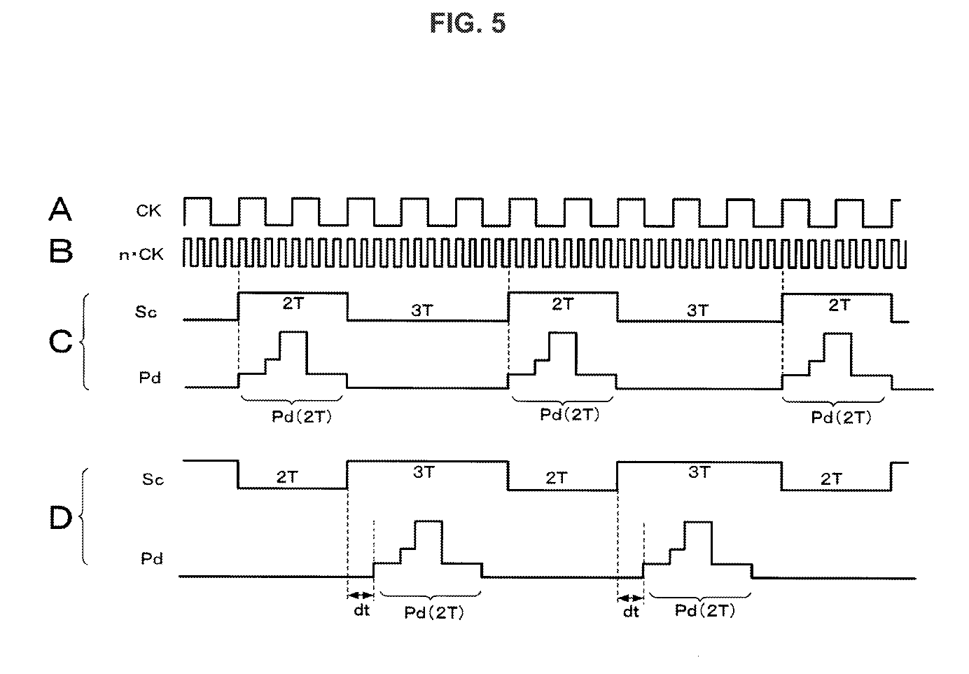

FIGS. 5A to 5D are diagrams illustrating waveforms. FIG. 5A shows the rotation synchronization clock CK and FIG. 5B shows the multiple clock n·CK.

To arrange the marks as in FIG. 4, the laser driving pulse Pd(2T) may be generated in synchronization with the rotation synchronization clock CK for a given specific period, as shown in FIG. 5C, for example, while laser exposure scanning is first performed in a track TK1.

That is, in this case, the laser driving pulse Pd(2T) for the 2T marks may be generated from the rising of the 3T period. For the purpose of generating merely this laser driving pulse to form the marks, the above-described exemplary configuration is not necessary. When the subsequent track TK2 is scanned, it is necessary to form marks located at positions which may not be defined using the rotation synchronization clock CK. That is, it is necessary to form the marks M at positions corresponding to timings shifted by a ½ period from the rising of the rotation synchronization clock CK in a track line direction.

The process according to this embodiment is applied in consideration of the fact that the marks are formed at the positions which may not be defined using the rotation synchronization clock CK.

First, the control signal generation unit 1 generates the control signal Sc in odd tracks TK1, TK3, and the like, as in FIG. 5C. In this case, the control signal Sc is assumed to have an H period of a 2T length and an L period of a 3T length. That is, the control signal Sc of the first value is provided at intervals of the 3T period.

The laser driving pulse generation unit 2 causes the exposure head unit 3 to output a laser beam using the laser driving pulse Pd(2T) in accordance with the control signal Sc and generates marks on the master disc 90.

On the other hand, the control signal generation unit 1 generates the control signal Sc in even tracks TK2, TK4, and the like, as in FIG. 5D. In this case, the control signal Sc is assumed to have an H period of a 3T length and an L period of a 2T length. That is, the control signal Sc of the second value is provided at intervals of the 2T period. Briefly speaking, the control signal Sc is a control signal that is obtained by reversing the phase of the control signal Sc shown in FIG. 5C. The laser driving pulse generation unit 2 generates the laser driving pulse Pd(2T) at a timing delayed only by the period dt in accordance with the control signal Sc. Thus, the laser driving pulse generation unit 2 causes the exposure head unit 3 to output a laser beam and generates the marks on the master disc 90.

Accordingly, the 2T marks M can be formed at the vertex positions of the regular triangles as shown in FIG. 4. That is, the marks can also be formed at the position which may not be defined using the rotation synchronization clock CK.

FIG. 4 shows one example in which the marks are formed. Of course, the marks can be formed at further various positions.

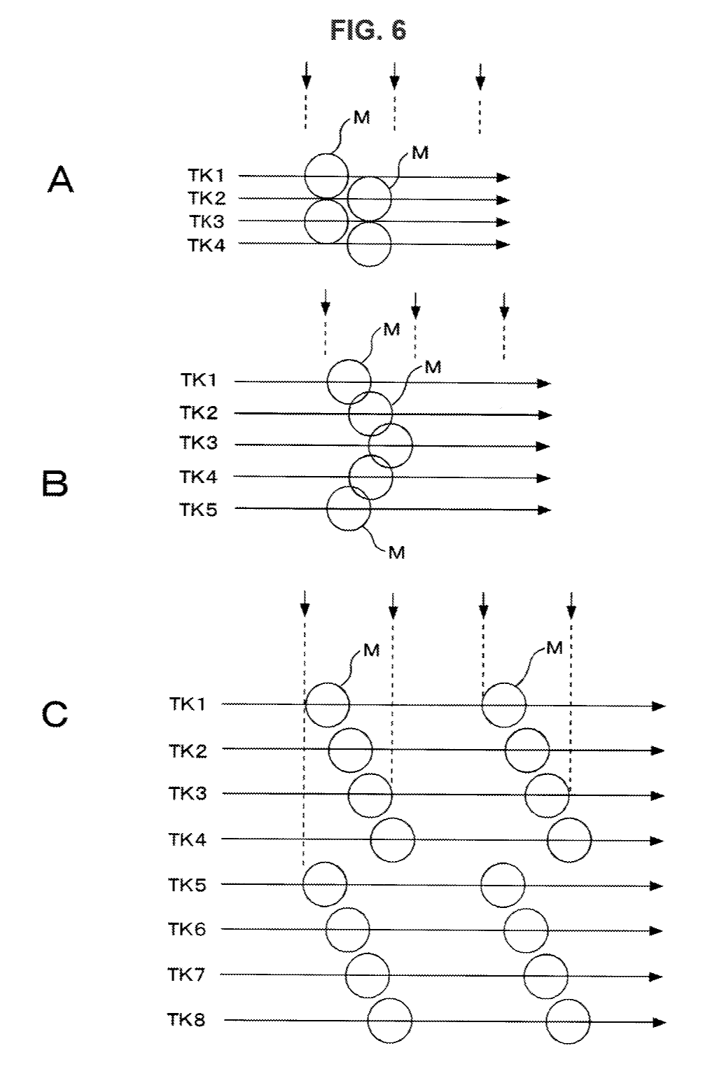

For example, marks M (pits) shown in FIG. 6A can be formed. In FIG. 6A, positions indicated by arrows are positions (positions at which the marks can be formed with the laser drying pulse Pd synchronized with the rotation synchronization clock CK) synchronized with the rotation synchronization clock CK.

In this case, for example, in tracks TK2 and TK4, the 2T marks M are formed at the positions delayed a ½ period from the rotation synchronization clock CK. However, as in FIGS. 5A to 5D described above, the mark arrangement (pit arrangement) as shown in drawings can be realized by controlling the timing of the laser driving pulse Pd(2T) in accordance with the control signal Sc.

### 3. GENERATION OF LASER DRIVING PULSE ACCORDING TO SECOND EMBODIMENT

A process of generating a laser driving pulse will be described according to a second embodiment. The second embodiment is basically the same as the first embodiment. However, in the second embodiment, for example, the control signals Sc have a “first value” to a “fourth value.”

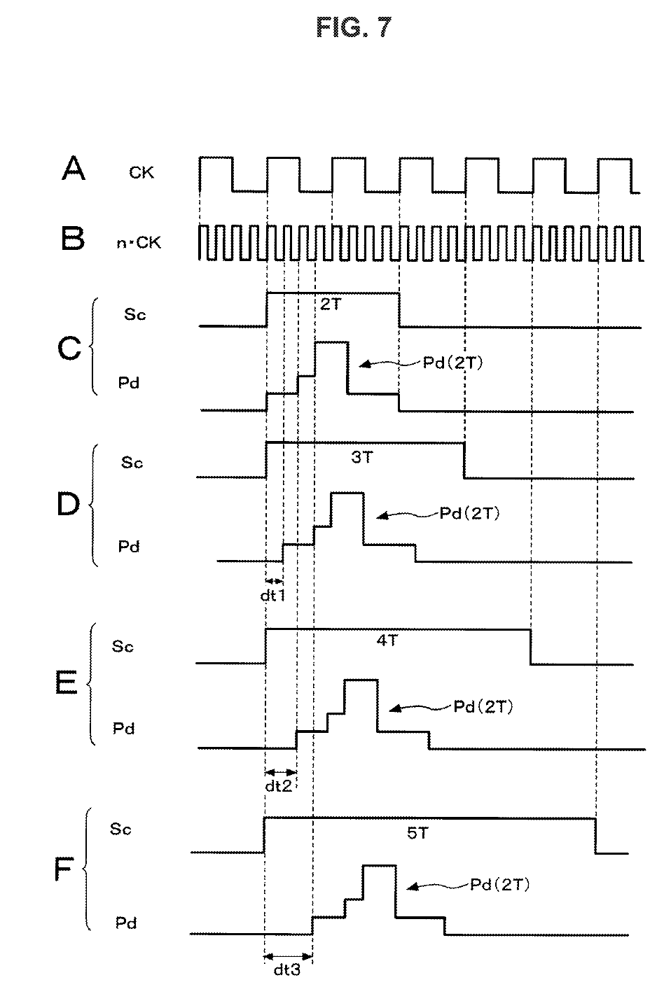

FIGS. 7A to 7F are diagrams illustrating waveforms. FIG. 7A shows a rotation synchronization clock CK and FIG. 7B shows a multiple clock n·CK.

FIGS. 7C, 7D, 7E, and 7F each show a control signal Sc output by the control signal generation unit 1 and the laser driving pulse Pd output by the laser driving pulse generation unit 2.

In FIG. 7C, in accordance with the control signal Sc (first value) with a 2T length, the laser driving pulse generation unit 2 generates the laser driving pulse Pd(2T) used to form 2T marks at the timing of the multiple clock n·CK coinciding with the rising timing of the rotation synchronization clock CK.

In FIG. 7D, in accordance with the control signal Sc (second value) with a 3T length, the laser driving pulse generation unit 2 generates the laser driving pulse Pd(2T) used to form the 2T marks by delaying a start timing of the laser driving pulse Pd(2T) by a period dt1 corresponding to a ¼ period from the rising of the rotation synchronization clock CK, that is, one clock of the multiple clock n·CK.

In FIG. 7E, in accordance with the control signal Sc (third value) with a 4T length, the laser driving pulse generation unit 2 generates the laser driving pulse Pd(2T) used to form the 2T marks by delaying a start timing of the laser driving pulse Pd(2T) by a period dt2 corresponding to a 2/4 period from the rising of the rotation synchronization clock CK, that is, two clocks of the multiple clock n·CK.

In FIG. 7F, in accordance with the control signal Sc (fourth value) with the 5T length, the laser driving pulse generation unit 2 generates the laser driving pulse Pd(2T) used to form the 2T marks by delaying a start timing of the laser driving pulse Pd(2T) by a period dt3 corresponding to a ¾ period from the rising of the rotation synchronization clock CK, that is, three clocks of the multiple clock n·CK.

The positions of the marks can be controlled at the higher resolution than the rotation synchronization clock CK by controlling the start timing of the laser driving pulse Pd in accordance with the control signal Sc.

In this example, the multiple clock n·CK is set as a fourfold clock of the rotation synchronization clock CK. However, a multiple clock n·CK with a higher frequency such as an eightfold frequency may, of course, be used. When this multiple clock n·CK with a higher frequency is used and the number of values indicated by the control signal Sc is larger, the timing of the laser driving pulse Pd can be controlled more minutely.

According to the second embodiment, the marks can be formed as in FIG. 6A, 6B, or 6C. In FIG. 6A, 6B, or 6C, positions indicated by arrows are positions synchronized with the rotation synchronization clock CK.

When the marks shown in FIG. 6A are formed, a laser driving pulse Pd(2T) synchronized with the rotation synchronization clock CK, as in FIG. 7C, is generated using the control signal Sc as the first value in the scanning of the tracks TK1 and TK3.

In the scanning of the tracks TK2 and TK4, the 2T marks M are formed at the position delayed by a ½ period from the rotation synchronization clock CK. Therefore, the laser driving pulse Pd(2T) delayed only by the period dt2, as in FIG. 7E, is generated using the control signal Sc as the third value.

Marks M (pits) shown in FIG. 6B can be formed.

In this case, for example, in tracks TK1 and TK5, the laser driving pulse Pd(2T) synchronized with the rotation synchronization clock CK, as in FIG. 7C, is generated using the control signal sc as the first value.

In tracks TK2 and TK4, the laser driving pulse Pd(2T) delayed only by the period dt1, as in FIG. 7D, is generated using the control signal Sc as the second value.

In a track TK3, the laser driving pulse Pd(2T) delayed only by the period dt2, as in FIG. 7E, is generated using the control signal Sc as the third value.

Thus, the mark arrangement (pit arrangement) shown in FIG. 6B can be realized.

When the marks M (pits) shown in FIG. 6C are formed, the laser driving pulse Pd(2T) synchronized with the rotation synchronization clock CK, as in FIG. 7C, is generated in tracks TK1 and TK5 using the control signal Sc as the first value.

In tracks TK2 and TK6, the laser driving pulse Pd(2T) delayed only by the period dt1, as in FIG. 7D, is generated using the control signal Sc as the second value.

In tracks TK3 and TK7, the laser driving pulse Pd(2T) delayed only by the period dt2, as in FIG. 7E, is generated using the control signal Sc as the third value.

In tracks TK4 and TK8, the laser driving pulse Pd(2T) delayed only by the period dt3, as in FIG. 7F, is generated using the control signal Sc as the fourth value.

Thus, the mark arrangement (pit arrangement) shown in FIG. 6C can be realized.

### 4. GENERATION OF LASER DRIVING PULSE ACCORDING TO THIRD EMBODIMENT

In a third embodiment, the control signal Sc does not express multiple values using a pulse length in the time axis direction, but multiple values are transmitted from the control signal generation unit 1 to the laser driving pulse generation unit 2 using a plurality of signal lines.

For example, a 2-bit signal is transmitted from the control signal generation unit 1 to the laser driving pulse generation unit 2 using two signal lines. That is, a 4-value signal with values of (0, 0), (0, 1), (1, 0), and (1, 1) is transmitted.

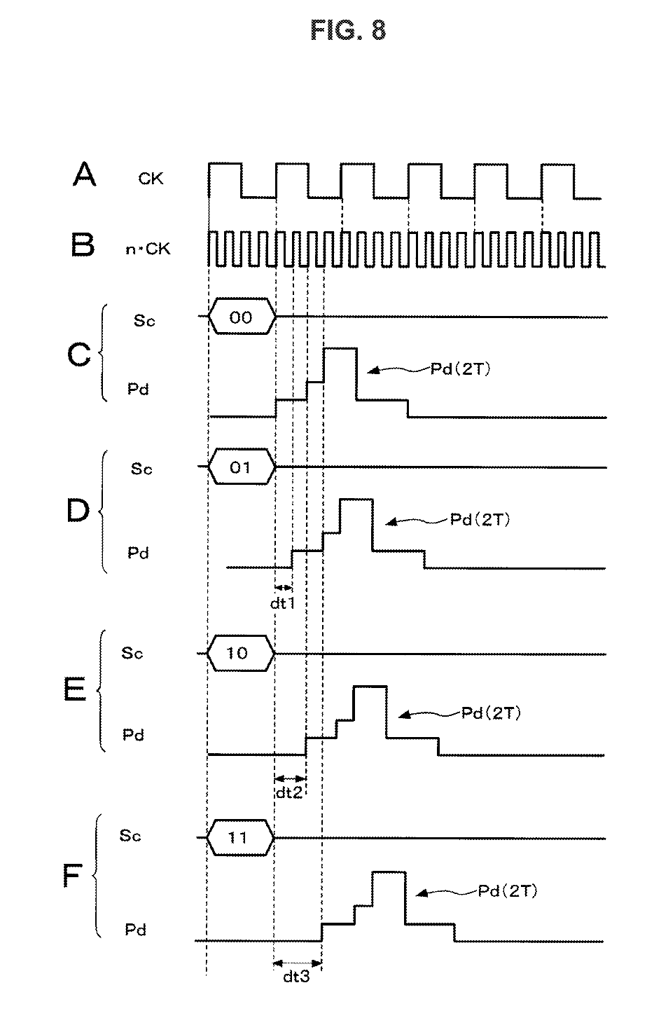

FIGS. 8A to 8F are diagrams illustrating signal waveforms. FIG. 8A shows a rotation synchronization clock CK and FIG. 8B shows a multiple clock n·CK. FIGS. 8C, 8D, 8E, and 8F each show control signals Sc output by the control signal generation unit 1 and the laser driving pulses Pd output by the laser driving pulse generation unit 2. The control signal Sc has a 2-bit value.

When the control signal Sc has the bit value of (0, 0), the laser driving pulse generation unit 2 generates the laser driving pulse Pd(2T) used to form the 2T marks at the timing of the multiple clock n·CK coinciding with the rising timing of the rotation synchronization clock CK (FIG. 8C).

When the control signal Sc has the bit value of (0, 1), the laser driving pulse generation unit 2 generates the laser driving pulse Pd(2T) used to form the 2T marks by delaying the start timing of the laser driving pulse Pd(2T) by the period dt1 corresponding to a ¼ period from the rising of the rotation synchronization clock CK, that is, one clock of the multiple clock n·CK (FIG. 8D).

When the control signal Sc has the bit value of (1, 0), the laser driving pulse generation unit 2 generates the laser driving pulse Pd(2T) used to form the 2T marks by delaying the start timing of the laser driving pulse Pd(2T) by the period dt2 corresponding to a 2/4 period from the rising of the rotation synchronization clock CK, that is, two clocks of the multiple clock n·CK (FIG. 8E).

When the control signal Sc has the bit value of (1, 1), the laser driving pulse generation unit 2 generates the laser driving pulse Pd(2T) used to form 2T marks by delaying the start timing of the laser driving pulse Pd(2T) by the period dt3 corresponding to a ¾ period from the rising of the rotation synchronization clock CK, that is, three clocks of the multiple clock n·CK (FIG. 8F).

Thus, the bit values of (0, 0), (0, 1), (1, 0), and (1, 1) are used to designate the period delays of the ¼ period, the 2/4 period, and the ¾ period of the rotation synchronization clock CK.

Thus, the positions of the marks can be controlled as in the above-described second embodiment. When the control signal Sc is configured to be transmitted as the multiple-value signal by the plurality of signal lines, a transmission time of one control signal Sc can be shortened. Therefore, the degree of freedom can be improved when the mark intervals are narrowed in the track line direction.

Of course, the marks can be considered to be formed at higher resolution by raising the multiple of the multiple clock n·CK and using the control signal Sc with 3 bits or more.

### 5. GENERATION OF LASER DRIVING PULSE ACCORDING TO FOURTH EMBODIMENT

In the first to third embodiments, the laser driving pulse Pd(2T) used to form the 2T marks has been generated based on the control signal Sc. However, when marks with a specific T length are not formed and marks with several mark lengths are formed, a timing can be controlled by the control signal Sc.

For example, the run-length designation signal MT is configured to be input to the laser driving pulse generation unit 2, as indicated by a dashed line in FIG. 1. The run-length designation signal MT may be generated by a control unit (not shown) or the control signal generation unit 1. The run-length designation signal MT is a signal that is used to designate a plurality of run lengths such as 2T, 3T, and 4T.

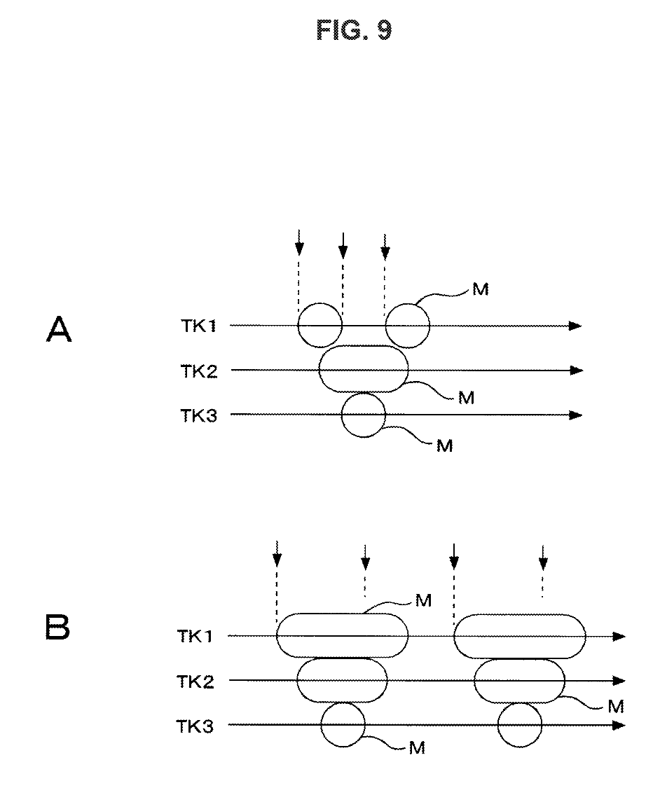

For example, as in FIGS. 9A and 9B, the positions of marks M with several kinds of T lengths such as 2T marks, 3T marks, and 4T marks are considered to be attempted to be controlled at higher accuracy than the resolution of the rotation synchronization clock CK. In FIGS. 9A and 9B, the positions indicated by arrows are positions of the marks synchronized with the rotation synchronization clock CK.

In FIG. 9A, 2T marks are formed at positions synchronized with the rotation synchronization clock CK indicated by the arrows in tracks TK1 and TK3. In a track TK2, a 3T mark is formed at a position delayed by a ½ period from the rotation synchronization clock CK.

In FIG. 9B, 4T marks are formed at positions synchronized with the rotation synchronization clock CK indicated by arrows in a track TK1. In a track TK2, 3T marks are formed at positions delayed by a ¼ period from the rotation synchronization clock CK. In a track TK3, 2T marks are formed at positions delayed by a 2/4 period from the rotation synchronization clock CK.

For example, when these marks are attempted to be formed, the laser driving pulse Pd is generated in accordance with a method to be described below.

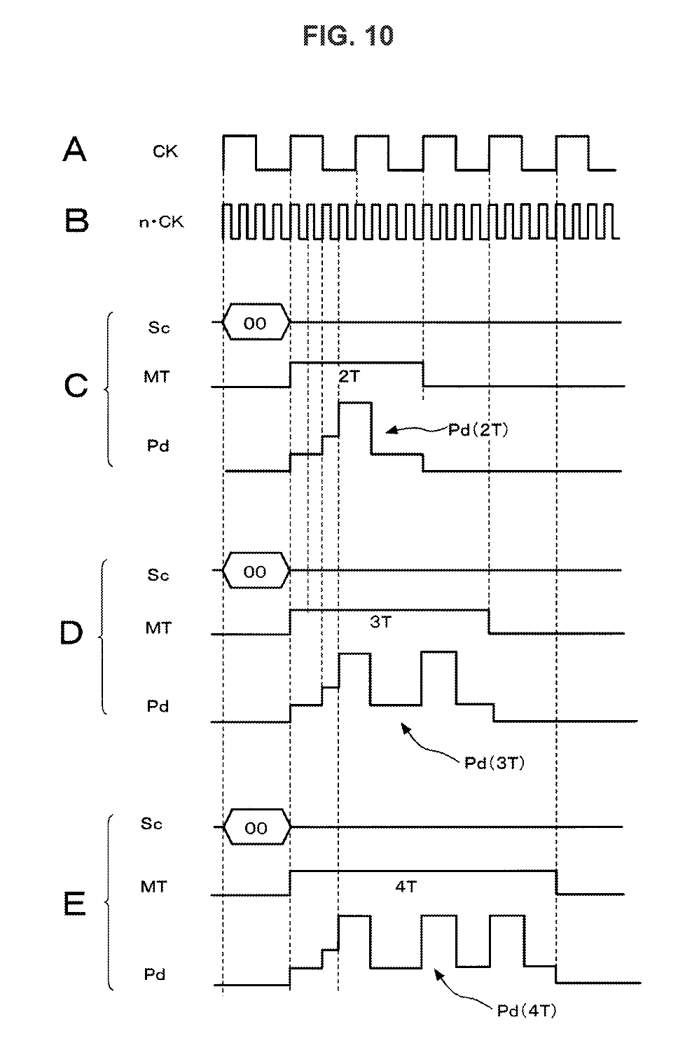

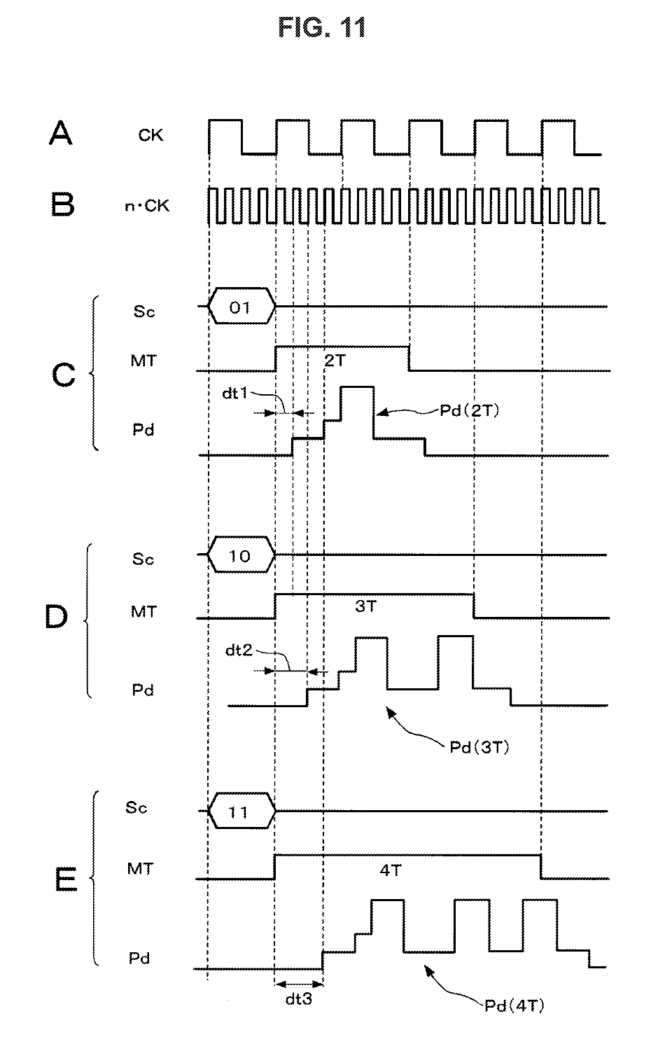

FIGS. 10A to 10E and FIGS. 11A to 11E are diagrams illustrating signal waveforms. FIGS. 10A and 11A each show a rotation synchronization clock CK and FIGS. 10B and 11B each show a multiple clock n·CK. FIGS. 10C, 10D, 10E, 11C, 11D, and 11E each show control signals Sc and the run length signals MT input to the laser driving pulse generation unit 2 and the laser driving pulses Pd output by the laser driving pulse generation unit 2. The control signal Sc has a 2-bit value, as in the above-described third embodiment. Further, the control signal Sc may be a signal that expresses multiple values in a pulse length in the time axis direction, as in the first and second embodiments.

FIGS. 10C, 10D, and 10E each show a case in which the control signal Sc has a bit value of (0, 0) and the laser driving pulse Pd synchronized with the rotation synchronization clock CK is designated to be output. FIGS. 10C, 10D, and 10E show the run-length designation signals of a 2T pulse, a 3T pulse, and a 4T pulse, respectively. The run-length designation signals MT designate 2T, 3T, and 4T as the pulse lengths, respectively. That is, the run-length designation signal MT is a signal that expresses a run length by a pulse length in the time axis direction.

Further, the run-length designation signal MT may be a signal that designates a run length by a 2-bit value, a 3-bit value, or the like.

In FIG. 10C, the run-length designation signal MT is set to designate 2T and the control signal Sc has a bit value of (0, 0). Then, the laser driving pulse generation unit 2 generates the laser driving pulse Pd(2T) used to form 2T marks at the timing of the multiple clock n·CK coinciding with the rising timing of the rotation synchronization clock CK.

In FIG. 10D, the run-length designation signal MT is set to designate 3T and the control signal Sc has a bit value of (0, 0). Then, the laser driving pulse generation unit 2 generates the laser driving pulse Pd(3T) used to form 3T marks at the timing of the multiple clock n·CK coinciding with the rising timing of the rotation synchronization clock CK.

In FIG. 10E, the run-length designation signal MT is set to designate 4T and the control signal Sc has a bit value of (0, 0). Then, the laser driving pulse generation unit 2 generates the laser driving pulse Pd(4T) used to form 4T marks at the timing of the multiple clock n·CK coinciding with the rising timing of the rotation synchronization clock CK.

The strategy waveform of the laser driving pulse Pd(3T) used to form the 3T marks shown in FIG. 10D or the strategy waveform of the laser driving pulse Pd(4T) used to form the 4T marks shown in FIG. 10E are merely examples, as in the laser driving pulse Pd(2T). The strategy waveform having each T is considered to be diversified.

FIGS. 11C, 11D, and 11E each show a case other than the case in which the control signal Sc has the bit value of (0, 0).

In FIG. 11C, the run-length designation signal MT is set to designate 2T and the control signal Sc has the bit value of (0, 1). Then, the laser driving pulse generation unit 2 generates the laser driving pulse Pd(2T) used to form 2T marks by delaying a start timing of the laser driving pulse Pd(2T) by a period dt1 corresponding to a ¼ period from the rising of the rotation synchronization clock CK, that is, one clock of the multiple clock n·CK.

In FIG. 11D, the run-length designation signal MT is set to designate 3T and the control signal Sc has the bit value of (1, 0). Then, the laser driving pulse generation unit 2 generates the laser driving pulse Pd(3T) used to form 3T marks by delaying the start timing of the laser driving pulse Pd(3T) by a period dt2 corresponding to a 2/4 period from the rising of the rotation synchronization clock CK, that is, two clocks of the multiple clock n·CK.

In FIG. 11E, the run-length designation signal MT is set to designate 4T and the control signal Sc has the bit value of (1, 1). Then, the laser driving pulse generation unit 2 generates the laser driving pulse Pd(4T) used to form 4T marks by delaying the start timing of the laser driving pulse Pd(4T) by a period dt3 corresponding to a ¾ period from the rising of the rotation synchronization clock CK, that is, three clocks of the multiple clock n·CK.

A case in which the run-length designation signal MT is set to designate 2T and the control signal Sc has the bit value of (1, 0) or (1, 1), a case in which the run-length designation signal MT is set to designate 3T and the control signal Sc has the bit value of (0, 1) or (1, 1), and a case in which the run-length designation signal MT is set to designate 4T and the control signal Sc has the bit value of (0, 1) or (1, 0) are not shown. However, the start timing of the laser driving pulse Pd used to form the marks with the designated run length is likewise controlled in accordance with the control signal Sc.

The length of the mark is designated by the run-length designation signal MT. In this case, the start timing of the laser driving pulse Pd is controlled in accordance with the control signal Sc.

Thus, when not only the marks with one specific run length but also the marks with several kinds of run lengths are formed, the positions of the marks can be controlled at the higher resolution than the rotation synchronization clock CK.

For example, when the marks are formed as in FIGS. 9A and 9B, the control signal generation unit 1 may generate not only the control signal Sc but also the run-length designation signal MT and supply the control signal Sc and the run-length designation signal MT to the laser driving pulse generation unit 2.

The recording data RD is a signal that is modulated in accordance with information to be recorded and is set to designate the run length of a mark. Accordingly, the recording data RD can be considered as one kind of run-length designation signal MT. Therefore, even when the laser driving pulse Pd is generated based on the recording data RD, the laser driving pulse generation unit 2 may control the start timing of the laser driving pulse Pd based on the control signal Sc.

### 6. EXAMPLE APPLIED TO BCA

Here, an example in which the process of forming the marks by controlling the timing of the laser driving pulse Pd, as described above, is applied to BCA recording will be described.

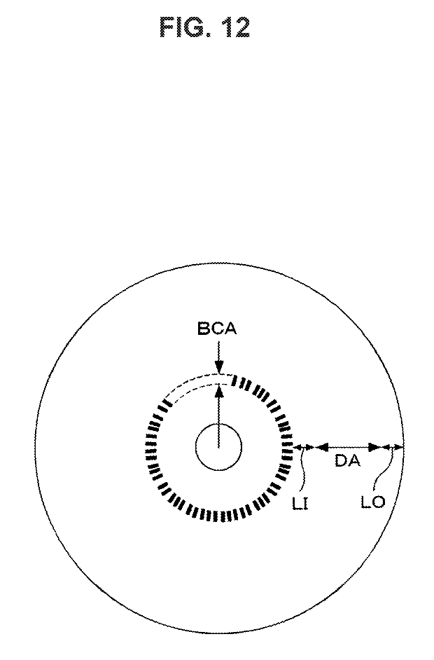

FIG. 12 is a diagram schematically illustrating the entire layout (region structure) of an optical disc. Examples of the optical disc include a Blu-ray disc (BD: registered trademark), a compact disc (CD), and a digital versatile disc (DVD).

As main regions on the optical disc, a lead-in zone LI, a data zone DA, and a lead-out zone LO are arranged from the inner circumference side.

In the lead-in zone LI, the physical characteristics, management information used for recording and reproduction, or the like is recorded. In the data zone, main data such as content data such as a video or music or computer-use data such as an application program is recorded. The lead-out zone LO is used as a buffer area, and management information is sometimes recorded in the lead-out zone LO.

In normal recording and reproduction processes, these zones are used. However, a BCA is provided to manage each disc on the inner circumference side from the lead-in zone LI.

In the BCA, a radial pattern is formed as a region with different reflection ratios. The BCA is considered as a region from which information can be read without tracking. In particular, in mass-produced optical discs, the BCA is used as a region in which information intrinsic to a disc, for example, information such as a serial number, is added.

In the BCA, as shown in the drawing, regions having a high reflection ratio and regions having a low reflection ratio which are arranged in a view from a track line direction are continuously formed in a track pitch direction (a radial direction) so as to have a reflection pattern with a barcode shape. For example, the regions having the high reflection ratio and the regions having the low reflection ratio are continuously formed in the radius range of 21.0 mm to 22.2 mm so as to have the barcode shape.

In this case, in the barcode-shaped pattern, information can be read without tracking within the range of the BCA.

In general, a unique ID or the like intrinsic to a disc recording medium is recorded in accordance with, for example, a recording method of burning out a recording layer. In this embodiment, for example, the region having the high reflection ratio is formed as a mirror surface and the region having the low reflection ratio is formed as a pit-formed surface.

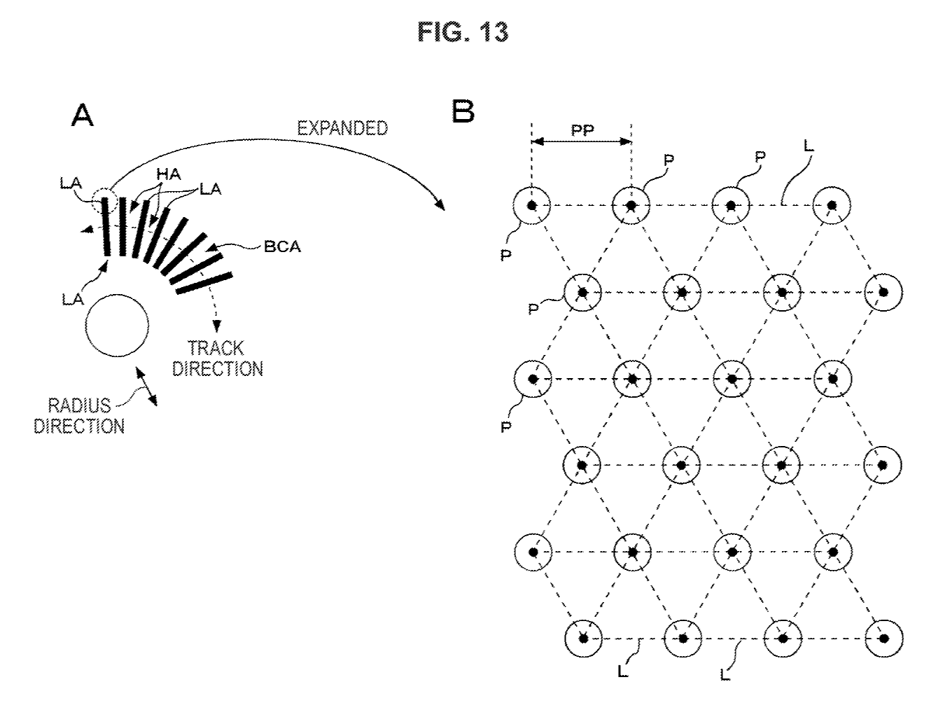

FIG. 13A is a diagram illustrating a radial barcode pattern of a BCA portion. A portion indicated by a black bar is a region LA having the low reflection ratio. The expanded region LA having the low reflection ratio is shown in FIG. 13B.

In the region LA having the low reflection ratio, as shown in FIG. 13B, pits P are formed so that each vertex position (indicated by a black circle) of a regular triangle indicated by a dashed line is located at substantially the center of the pit P.

That is, when lines forming several continuous regular triangles are drawn virtually on the surface of the region LA having the low reflection ratio, as in the drawing, the pits P are formed to contain the vertex positions of the lines of the virtually drawn regular triangles. Thus, all of the pit lines are arranged in parallel in a so-called zigzag form so as to be shifted in each track.

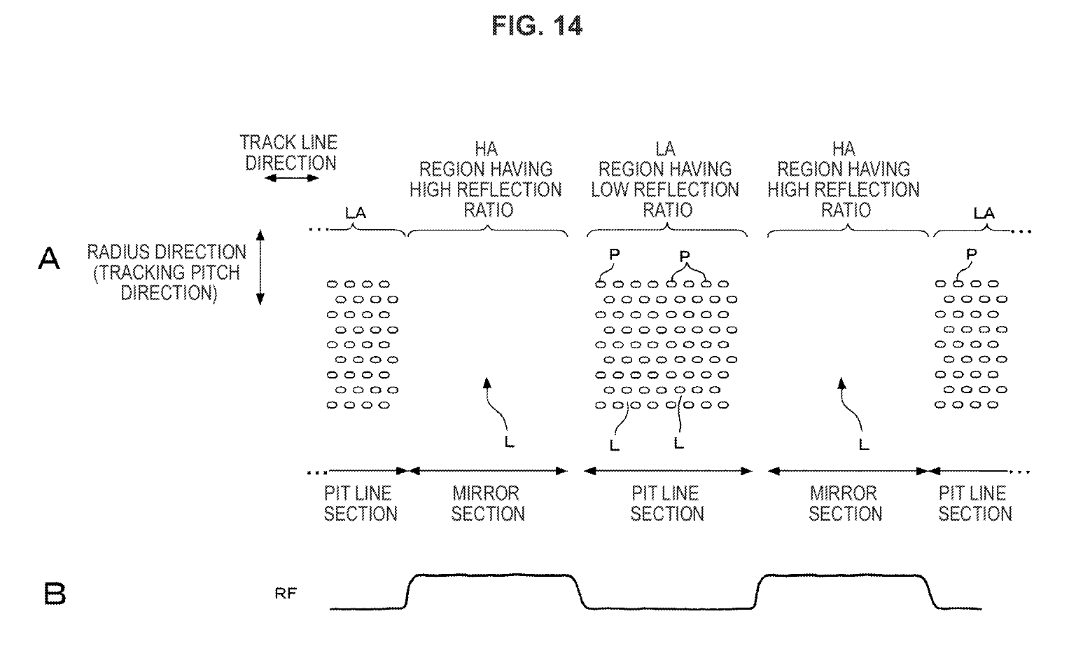

FIGS. 14A and 14B are diagrams schematically illustrating the BCA.

In FIG. 14A, the regions LA having the low reflection ratio and the regions HA having the high reflection ratio are formed alternately in the track line direction. The region LA having the low reflection ratio is configured as a pit line section formed by pits P and lands L and the region HA having the high reflection ratio is configured as a mirror section.

In the pit lines of the region LA having the low reflection ratio, the pits P are formed so that the vertex positions of the regular triangles are used as references.

When the BCA is reproduced by a reproduction apparatus, a waveform of an RF signal (reproduction signal) can be obtained, as in FIG. 14B. That is, in the region HA having the high reflection ratio as the mirror section in which the pits P are not formed, the high reflection ratio can be obtained. Therefore, the waveform of the RF signal has a high level.

On the other hand, in the region LA having a low reflection in which the pit lines are formed, reflected light can be obtained in accordance with the pit line. However, since the amount of reflected light is less in the pit line section than in the mirror section, the level of the RF signal is low.

A reproduction apparatus can obtain information of “1” and “0” based on a difference in the amplitudes of the RF signals between the region HA having the high reflection ratio and the region LA having the low reflection ratio and thus read information recorded in the BCA.

When such a BCA structure is used, a process of manufacturing an optical disc can be simplified.

In a method of burning out a recording layer according to the related art, a reflection film is burned out in each manufactured optical disc using a BCA recording apparatus that outputs a high-power laser.

However, when the BCA is formed in the mirror section and the pit line section, it is not necessary to form the BCA in each optical disc.

That is, the exposed mark portions are formed as concave portions by forming an exposed mark pattern corresponding to the pit line of the region LA having the low reflection ratio in the mastering of the master disc 90. In the region HA having the high reflection ratio, a non-exposed portion is used as a convex portion corresponding to the land L.

The stamper is created from the master disc, and optical discs are mass-produced using the stamper. Then, the BCA is already formed when optical discs are mass-produced.

When the BCA is provided, exposed marks corresponding to the pits of the region LA having the low reflection ratio are formed on the master disc 90 in the mastering of the master disc 90. The 2T marks are formed at the vertex positions of the regular triangles, as shown in FIG. 13B.

In this case, the formation positions of the marks have to be controlled. In the first embodiment, the marks shown in FIG. 4 can be formed, that is, the exposed marks M arranged in the regular triangles can be formed by generating the laser driving pulse Pd, as described with reference to FIGS. 5A to 5D.

As a result, in a given optical disc which is a final product, the portions of the exposed marks M are turned to the pits P, and thus the BCA in which the region LA having the low reflection ratio is formed is formed by a 2T pit group having the regular triangle arrangement, as in FIG. 13B.

Here, the regular triangle arrangement has been exemplified. However, the regions LA of various pit arrangement patterns having the low reflection ratio can be formed, since the formation positions of the marks can be controlled more minutely, as in the first to fourth embodiments described above.

### 7. MODIFIED EXAMPLES

The embodiments have been described, but the technology according to the embodiments of the present disclosure may be modified in various ways.

According to an embodiment of the present disclosure, the formation positions of the marks (pits) can be set at resolution exceeding the limit of a reference clock such as the rotation synchronization clock CK. Therefore, an application can be realized not only when the pit pattern is formed in the above-described BCA, but also when drawing is performed by pits on an optical disc or a specific pit arrangement pattern is formed.

For example, various shape drawings can be realized by controlling the formation positions of the marks based on the control signal Sc described in the embodiments, setting a track pitch when the marks are formed, and using the run-length designation signal MT. For example, characters, numerals, various signs, straight-line patterns, curve patterns, any shape, or the like can be drawn minutely. In particular, these characters, numerals, various signs, straight-line patterns, curve patterns, any shape, or the like can easily be drawn in a rotation recording system using a disc recording medium.

In the above-described embodiments, the mark forming apparatus has been applied to the mastering apparatus of the master disc 90. However, the mark forming apparatus according to the embodiments of the present disclosure may be applied to a recording apparatus for a recordable type disc (a rewritable type disc, a write-once-type disc, or the like) which is an optical disc such as a CD, a DVD, or a BD.

The recording apparatus for such an optical disc forms phase-change marks, pigment-change marks, or the like on an optical disc through laser beam irradiation. However, the positions of marks to be formed can be controlled at high resolution exceeding the limit of a recording reference clock by supplying the control signal Sc and the multiple clock n·CK to a unit that generates a laser driving pulse and controlling a start timing of the laser driving pulse.

The technology according to the embodiments of the present disclosure is, of course, applicable to recording apparatuses, mastering apparatuses, or the like for various recording media such as an optical disc recording medium, card type (non-circular type) recording medium such as an optical recording card or a semiconductor exposure mask, or a volume-type recording medium (for example, volume-type hologram-type recording medium). That is, irrespective of the shape or a kind of a recording medium, marks can be formed with the high degree of freedom without restriction of a synchronization reference signal by generating a multiple signal which is a multiple of the synchronization reference signal synchronized with a process of forming marks on the recording medium and setting a start timing of a laser driving pulse at resolution based on the multiple signal in accordance with a control signal. Thus, desired shapes, characters, signs, or the like can be expressed in a mark arrangement manner on various kinds of recording media.

It should be understood by those skilled in the art that various modifications, combinations, sub-combinations and alterations may occur depending on design requirements and other factors insofar as they are within the scope of the appended claims or the equivalents thereof.

What is claimed is:

1. A mark forming apparatus comprising:
a head unit that forms a mark on a recording medium through laser beam irradiation based on a laser driving pulse;
a control signal generation unit that generates a control signal at a start timing of the laser driving pulse supplied to the head unit;
a multiplier that multiples a synchronization reference signal used to synchronize with the process of forming the mark on the recording medium in the head unit to generate a multiple signal; and
a laser driving pulse generation unit that generates the laser driving pulse by setting the start timing of the laser driving pulse at resolution based on the multiple signal in accordance with the control signal.

2. The mark forming apparatus according to claim 1, wherein the laser driving pulse generation unit generates a laser driving pulse used to form a mark with a specific run length by setting the start timing of the laser driving pulse at the resolution based on the multiple signal in accordance with the control signal.

3. The mark forming apparatus according to claim 1,
wherein the recording medium is an optical disc recording medium,
the head unit forms the mark on the optical disc recording medium driven rotatably through the laser beam irradiation, and
the synchronization reference signal is a rotation synchronization signal synchronized with the rotation of the optical disc recording medium.

4. The mark forming apparatus according to claim 1, wherein the control signal generation unit generates the control signal as a multi-value signal that expresses two or more values using pulse lengths in a time axis direction.

5. The mark forming apparatus according to claim 1,
wherein a run-length designation signal used to designate a run length of the mark formed on the recording medium is input to the laser driving pulse generation unit, and
the laser driving pulse generation unit generates a laser driving pulse used to form a mark with the run length indicated by the run-length designation signal by setting a start timing of the laser driving pulse at the resolution based on the multiple signal in accordance with the control signal.

6. A mark forming method comprising:
generating a control signal at a start timing of a laser driving pulse;
multiplying a synchronization reference signal synchronized with a process of forming a mark on a recording medium to generate a multiple signal;
generating the laser driving pulse by setting the starting timing of the laser driving pulse at resolution based on the multiple signal in accordance with the control signal; and
forming the mark on the recording medium through laser beam irradiation based on the generated laser driving pulse.
